(19) United States
(12) Patent Application Publication
(10) Pub. No.: US 2016/0225357 A1
(43) Pub. Date: Aug. 4, 2016

(54) Movement Musical Instrument

(71) Applicants: Jet Black, Paso Robles, CA (US); Peter Morgan Busch, Chatsworth, CA (US)

(72) Inventors: Jet Black, Paso Robles, CA (US); Peter Morgan Busch, Chatsworth, CA (US)

(21) Appl. No.: 14/564,086

(22) Filed: Jan. 30, 2015

(51) Int. Cl. G10H 1/00; G10H 7/00

(52) U.S. Cl. CPC G10H 1/0008; G10H 7/00; G10H 2220/201; G10H 2220/135; G10H 2220/336; G10H 2220/326

(57) ABSTRACT

A wearable wireless device. The wireless device has musical functionality. The wireless device captures, processes, and transmits movement information to an app based device.

### CROSS-REFERENCE TO RELATED APPLICATIONS

This application claims the benefit of provisional patent application Ser. No. 61/963512, filed 2013 Dec. 6 by the present inventor.

### BACKGROUND OF THE INVENTION

Music creation and performance has become increasingly popular and the gratification from such activities is well known. Various types of instruments have been incorporated into music and other sound based performance activities. For example, a wide variety of instruments are available for use in creating and performing music such as guitars and other stringed instruments, drums and other percussion instruments, horns and other brass instruments, woodwinds and other reed instruments, as well as electronic technology instruments like software based controllers, keyboards, samplers, etc. Many music enthusiasts or musicians use one ore more of these instruments in the creation and performance of music.

Advances in technology have also allowed for new platforms to create, edit, produce, perform, and share music via app based devices. These platforms bring the experience of creating music to any user regardless of age, experience, skill, talent, or education level. For example one platform may incorporate a keyboard, a drum set, a guitar, a sampler, and a microphone where the user generates a song using these elements on the app based device. While app based device platforms according to prior art provide a number of advantageous features, they nevertheless have certain limitations. For example, some users prefer a more interactive experience than is possible from a platform on an app based device. Other platforms have limited functionality due to the restrictions of the app based device. The present invention seeks to overcome the limitations and drawbacks of the prior art and provide new features not previously available to the user.

### SUMMARY OF THE INVENTION

The present invention provides a wireless type device having musical functionality. The invention utilizes a sensor that detects movement, a microprocessor that processes the movement information, and a wireless transmitter that transmits the movement information to an app based device.

In one embodiment, the wireless device is housed in an enclosure and is wearable. The wireless device in this wearable form could be worn on the wrist, around the ankle, on the head, or any part of the body.

In another embodiment, the wireless device housed in an enclosure and is attached to the clothing. In this form the wireless device is removable and could be freely placed on the desired location.

In yet another embodiment, the wireless device housed in an enclosure could be manufactured as part of a garment. In this form the wireless device could be placed in the sole of the shoe, in the tongue of the shoe, in a pair of gloves, in a hat, in the sleeves of a shirt, or any place that could accommodate such a device.

### BRIEF DESCRIPTION OF THE DRAWINGS

FIG. 1 is a partial perspective drawing of the invention affixed to the tongue of the shoe.

FIG. 2 is a partial perspective drawing of the invention worn on the wrist.

FIG. 3 is a block diagram of the general components of the invention.

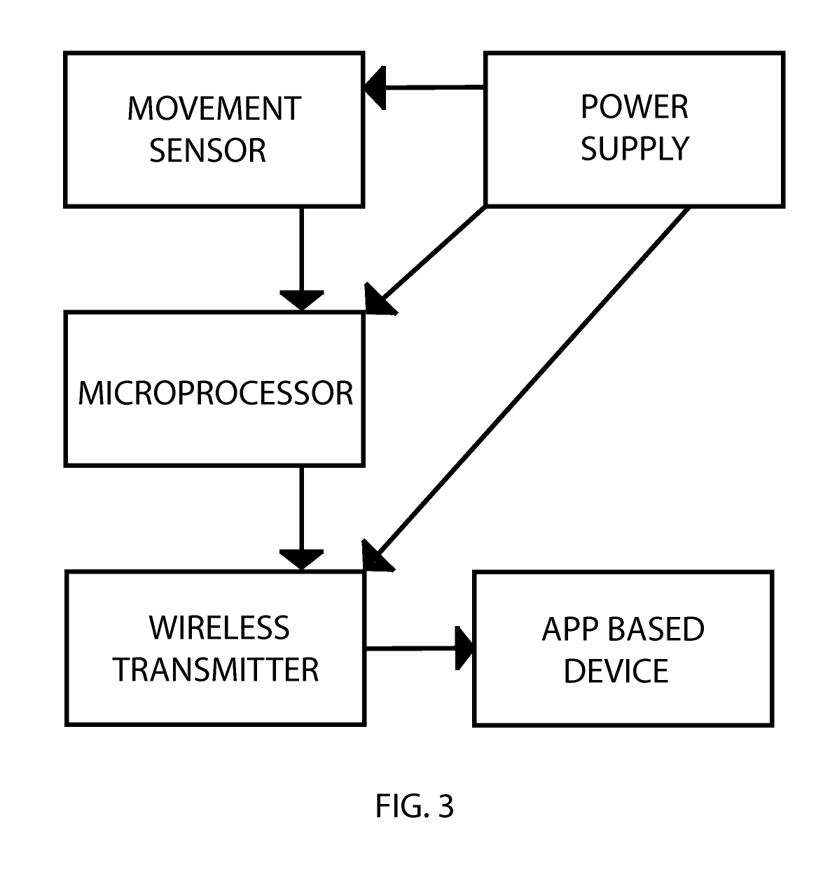

### DETAILED DESCRIPTION

The present invention provides a wireless type device having musical functionality. The present invention has a power supply and utilizes a sensor that detects movement. The movement information is sent to a microprocessor that is programmed to employ the gathered information. The processed information is transmitted via wireless transmitter to an app based device.

The movement information that can be captured, processed, and transmitted includes, but is not limited to foot strikes, foot taps, foot stomps, walking movements, dancing movements, jumping movements, hand gestures, hand claps, arm and leg shakes, hand waving, head nods, etc. Any movement significant enough that it can be captured by the sensor will suffice.

Combinations of movements can be utilized as well, for instance two foot taps and a stomp, one head nod and a clap, or one knee slap with a stomp and two claps. The programming of the microprocessor to accept combinations of movements is dependent on the intricacy of instrumentation desired.

The app based device having an app that receives the movement information outputs music that is generated by the movements. The user is able to assign instrument sounds to the corresponding wireless device, i.e. left arm is a piano, right arm is a trumpet, left foot is a kick drum, right foot is a snare drum.

As music is played by an instrument, the wireless device acts as a controller for the app based device. In this way, the wireless device can be utilized by the app based device to control other apps such as music players, dancing games, etc. The end use of the wireless device depends on the developer of the apps.

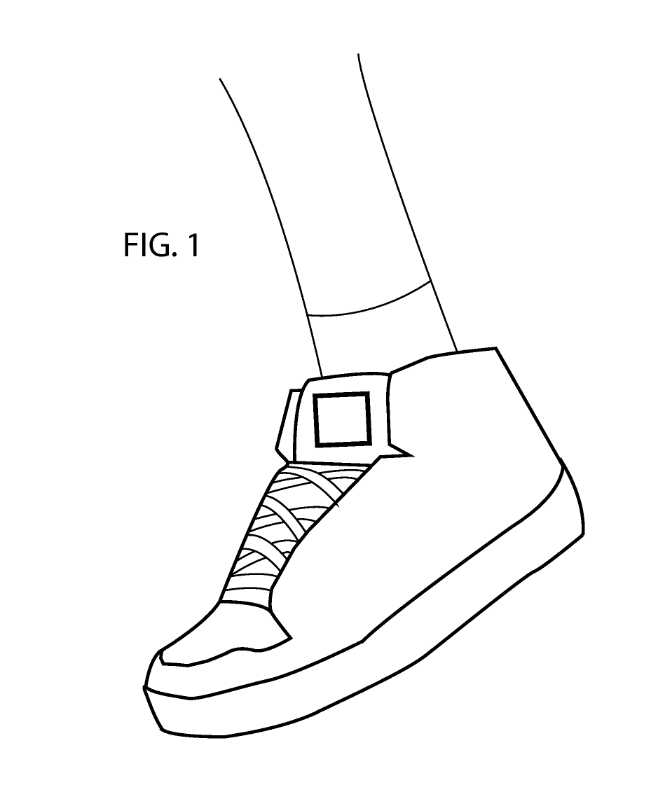

In one embodiment shown in FIG. 1 the wireless device is housed in an enclosure and mounted on the tongue of the shoe. In this embodiment, the power supply would be provided by an energy harvesting transducer where energy is stored in a capacitor. This would negate the use of batteries and allow the movement itself to generate the power necessary to operate the wireless device.

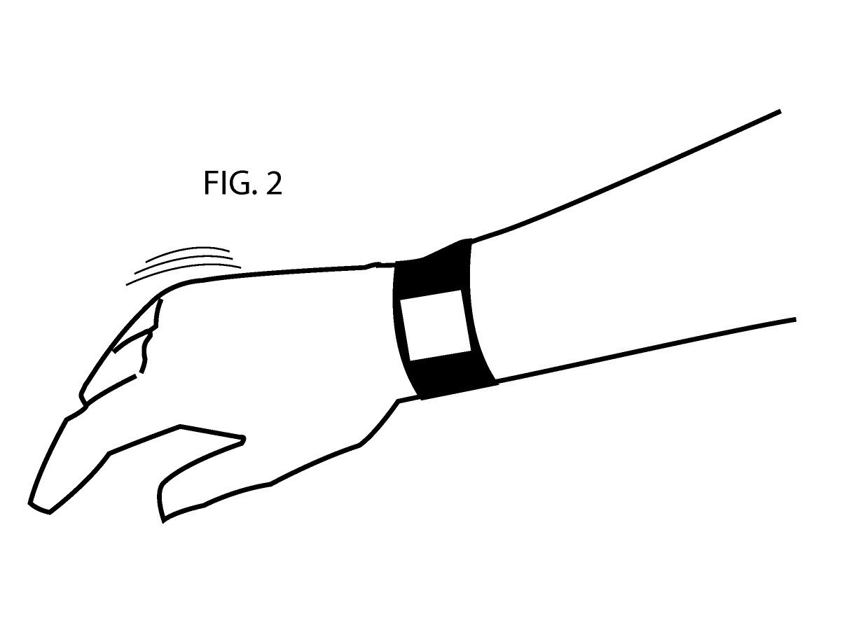

In another embodiment shown in FIG. 2 the wireless device is housed in an enclosure and is worn on the wrist. In this embodiment the wireless device is moveable and could be worn on any part of the body.

### CONCLUSION

As the invention has been explained with respects to assembly, function, and use, it should be noted that those skilled in the art would recognize the various ways to carry out this invention and that the construction and uses are not limited to those specifically stated above. Likewise, it may or may not be necessary to employ every aspect represented above to attain the desired result.

I claim:

1. A wearable electronic music creation device for capturing movement information as produced by the wearer and which transmits said information to an app based mobile device.
